(19) United States
(12) Patent Application Publication
(10) Pub. No.: US 2016/0349350 A1
(43) Pub. Date: Dec. 1, 2016

(54) PRODUCT AND EQUIPMENT LOCATION AND AUTOMATION SYSTEM AND METHOD

(71) Applicant: HDS Global, Inc., Palo Alto, CA (US)

(72) Inventors: Louis Borders, Palo Alto, CA (US); Ari Staiman, Palo Alto, CA (US); Charles DUNCHEON, Palo Alto, CA (US); Aravind DURAI, Palo Alto, CA (US); Ramesh SEKHAR, Palo Alto, CA (US); Eli GILD, Palo Alto, CA (US)

(21) Appl. No.: 14/985,199

(22) Filed: Dec. 30, 2015

Related U.S. Application Data
(60) Provisional application No. 62/230,132, filed on May 28, 2015.

(51) Int. Cl. G01S 5/02; G01S 5/14; G06K 7/10

(52) U.S. Cl. CPC G01S 5/0294; G06K 7/10366; G01S 5/14

(57) ABSTRACT

A system for location of assets on a premises is described. The system uses an RFID tag which is attached to an asset to be tracked. The system also employs an array of RFID tag readers placed in known locations within the premises. Each RFID tag reader activates and obtains tag information from a passing tag. The system also includes a control logic. The control logic reads information from the array of RFID tags and the control logic triangulates the position of each tracked asset.

### PRIORITY CLAIM

The instant application claims priority as a non-provisional of U.S. Provisional Application Ser. No. 62/230,132 filed on May 28, 2015, presently pending, the contents of which are incorporated herein by reference.

### BACKGROUND OF THE INVENTION

1. Field of the Invention

The field of the invention is a locating or tracking system for tangible objects (such as inventory, reagents, medicines, other products, and personnel) designed to automate distribution tasks within an enclosed space where traditional location technologies are not operable.

2. Background of the Invention

In various embodiments, the invention provides a multi-tier location system capable of real-time location and identification of assets within an enclosed space, such as a warehouse.

In one embodiment, the invention comprises a system which uses a large number of low-cost identification tags for individual assets, a dense array of readers which track the low-cost tags, and a top level logic tier which analyses the data from the readers.

Traditionally, fulfillment centers have incorporated tracking only for high-value assets and on an ad hoc basis with manual and work-intensive scanning of identifiers such as bar codes. In such systems, real-time tracking is implemented for only a subset of the tracked inventory, if at all. In the instant invention, the operator of a facility can track any identified item, using low cost devices, in real-time with a knowable level of precision.

A need exists in the art for a system that tracks items in locations where conventional location techniques are not functional or do not provide sufficient granularity.

### SUMMARY OF INVENTION

An object of the invention is to create a device and method for tracking of assets within the premises. An advantage of the invention is that it allows for real-time control of inventory, machinery, and other assets.

Another object of the invention is to provide reliable location information in environments where traditional location technologies do not function. A feature of the invention is that it employs a multi-tier system to provide location information for tagged assets. An advantage of the invention is that it allows for location of assets indoors and in other environments where traditional location technologies cannot be implemented.

Yet another object of the invention is to provide information while relying on simple and inexpensive identification tags. A feature of the invention is that the first tier of the system relies on passive RFID tags requiring little to no customization. An advantage of one embodiment is that the system can be scaled without incurring high costs per item.

A further object of the invention is to provide a system wherein location of a tagged asset is ascertained reliably. A feature of the invention is that in one embodiment multiple tiers of the system are used to reliably locate any one given tag. An advantage of the system is that it facilitates asset location while using multiple simultaneous readings from each tag.

Another object of the invention is to provide a system with redundancy features. A feature of the invention is in one embodiment, a multitude readers form an array of readers. A benefit of the invention is that a single point of failure does not exist within the system.

An additional object of the invention is to provide a system which can read asset identification tags in environments which include interference or which suffer from signal distortion. A feature of the invention is that the array of readers results in tags being detected in even difficult conditions. A benefit of the system is that assets are not misidentified and can be accounted for with known levels of precision.

A further object of the invention is to provide detailed analysis of data from many sources. A feature of the system is that in one embodiment a third layer of the system provides logic and analysis tools to convert raw data into actionable reports. A benefit of the system is that it gathers readings from many sensors simultaneously and provides actionable information from the raw sensor readings on demand or in real-time.

An additional object of the invention is to provide a system capable of being adapted to various environmental difficulties. A feature of the invention is that the design and layout of the reader sensors may be customized to account for problematic features within the environment of the asset tracking system. In one embodiment of the invention, the interference, number of readouts required, and other parameters are used in designing the layout of the middle tier of the system. A benefit of the system is that it is flexible and can be applied to demanding scenarios.

A further object of the invention is to provide a system which relies on power-efficient components. A feature of the invention is that, in one embodiment, several of the tiers use passive components and active components that do not draw large amounts of current. A benefit of the invention is that the many of the components do not require power sources and the tiers that require powered components can use long-life batteries and other convenient power sources.

An additional object of the invention is to create a tracking system which does not add manual steps or overhead to the asset management tasks. A feature of the invention is that the need for manual scanning or physical confirmation of inventory is obviated. A benefit of the invention is that a system incorporating an embodiment of the invention can be run automatically.

A further object of the invention is to facilitate a large scale deployment of a tracking system. A feature of the invention is that the system components can be scaled to any real-world scenario. A benefit of the invention is that the system may be deployed to account for locations of all assets in an environment.

An additional object of the invention is to provide a way to track dissimilar products. In one embodiment, a feature of the invention is that the tagging of assets can be done using a number of different tags, depending on the type of asset to be tagged. A benefit of the system is that it allows for flexibility in selecting type of lowest level identification tags.

A system for location of assets on a premises comprising an RFID tag attached to an asset to be tracked; an array of RFID tag readers placed in known locations within said premises wherein said RFID tag readers activate and obtain tag information from each tag; and a control logic wherein said control logic reads information from said array of RFID tags; wherein said control logic triangulates the position of each tracked asset.

### BRIEF DESCRIPTION OF DRAWING

The invention together with the above and other objects and advantages will be best understood from the following detailed description of the preferred embodiment of the invention shown in the accompanying drawings, wherein:

FIG. 1 depicts an overview of a prior art system;

FIG. 2 depicts an overview of one embodiment of the invention;

FIG. 3 depicts a detailed view of one tier pursuant to one embodiment of the invention;

FIG. 4 depicts a schematic of one embodiment of the invention;

FIG. 5 depicts a schematic of a different embodiment of the invention;

FIG. 6 depicts a data packet which is received by a tier of the system in one embodiment of the invention; and

FIG. 7 depicts an overview of one embodiment of the invention.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

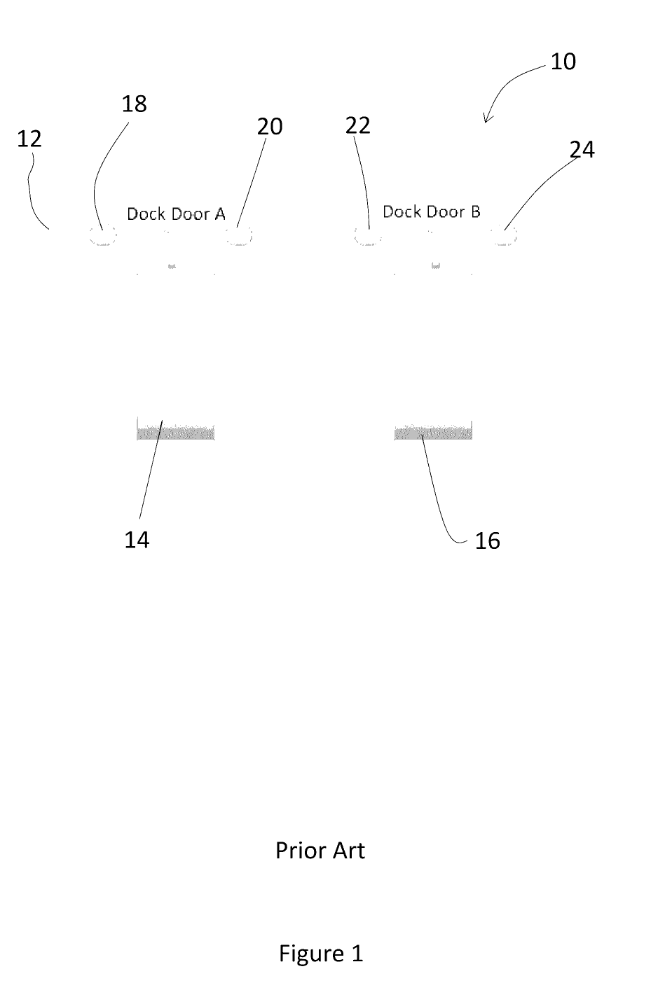

Turning to the figures, FIG. 1, depicts a prior art approach 10 for single-point tracking. In the prior art approach 10, a series of tag readers 18, 20, 22, 24 are placed in strategic locations in a facility. As shown in FIG. 1, the strategic location is defined by the outer wall 12 which includes a pair of doors. Inventory from the facility is being transported using a first forklift 14 and a second forklift 16.

The first forklift 14 is approaching the first door which is surrounded by the first 18 and second 20 tag readers. The second forklift 16 is approaching the second door, which is surrounded by the third 22 and fourth 24 tag readers. In an optimum scenario under the prior art system, all the tags carried by the first forklift 14 would be read by either the first reader 18 or the second reader 20. Likewise all the tags carried by the second forklift 16 would be read by the third reader 22 and the fourth reader 24. In reality, however, there is cross-over in the tag readouts. As such, some of the tags on the first forklift 14 will mistakenly be read by the third 22 or fourth 24 readers. Conversely, some of the tags on the second forklift 16 will be mistakenly read by the first 18 and second 20 reader. Furthermore, some of the tags will be read by none of the four readers.

If a tag is read by the unintended reader then it may be identified as having been transported with the incorrect shipment. Such incorrect readings result in lost inventory and often require manual checking of cargo. Tags which pass unread also create problems of maintaining correct inventory.

In real-world scenarios the prior art system 10 depicted in FIG. 1 would be capable of correctly identifying the point and time of departure for about 90% of the inventory leaving the facility.

Prior art approaches use readers 18, 20, 22, 24, which are bulky and expensive. Further, the prior art readers 18, 20, 22, 24 can interfere and compete with one another. The readers act as independent devices and so adding more readers results in diminishing benefits, while the costs remain high. In some prior art approaches, each reader costs more than $1000.

Given the cost of incorporating readers 18, 20, 22, 24 into the system, prior art approaches have only a few strategic locations where the readers are found. In the embodiment of FIG. 1, the system is only able to detect once inventory is leaving the facility. For example, there is no way to detect the path that the first forklift 14 took in approaching the wall 12. As such, the prior art system 10 is not readily useable for inventory tracking within the facility.

In order to address these shortcomings, most prior art systems 10 add manual checks and additional identification tasks which use non-RFID based systems, such as optical scanners, image detection, bar codes, and the like. The result is that prior art systems 10 are complicated, expensive, and yet lack tracking features that would add value to the business process.

### Three Tier Design

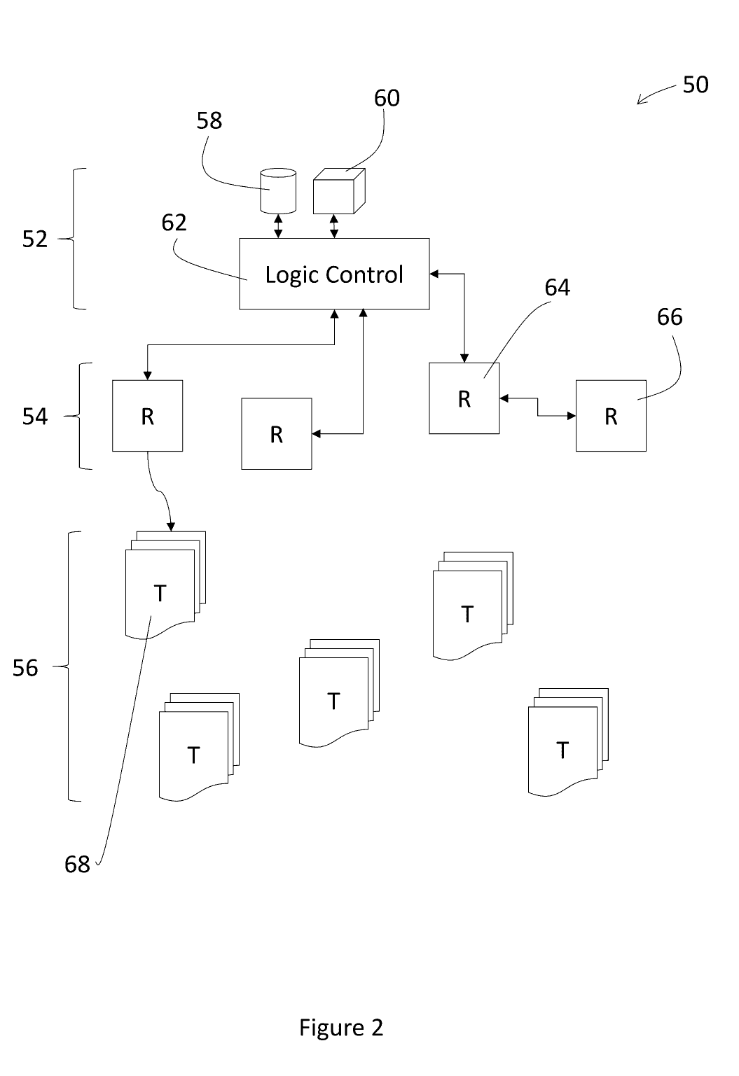

As shown in FIG. 2, the invented system 50 comprises three logical layers 52, 54, 56, in one embodiment, that overcomes the drawbacks of the prior art. The system uses a logic layer 52 to manage the remaining components. In communication with the logic layer 52 is the reader layer 54. Members of the reader layer 54 activate and read the identifiers of the tag layer 56.

As shown in FIG. 2, the logic layer 52 comprises at least one logic controller 62. The logic layer 52 further includes at least one data store 58 and at least one user interface 60. In one embodiment, the logic controller 62, data store 58, and at least one user interface 60 are implemented in a single system, such as a server having access to a database management software and an interface, such as a web-based reporting interface which generates reports on the basis of information found in the data store 58. The logic controller 62, however, is not a passive device, in one embodiment, and performs calculations on the data stored in the data store 58, such as triangulation discussed supra.

In another embodiment, the logic controller comprises distributing computing resources in communication with one another with data store 58 shared between the computing resources and resulting user interface 60. In one embodiment, the logic controller 62 is physically located in the same facility as the rest of the system components, in another embodiment, the logic controller 62 is located at a physically remote site.

The reader layer 54 of the system comprises a network of RFID readers (designated with the letter R in the schematic). As shown in FIG. 2, the RFID readers of the reader layer 54 are in two-way communication with the logic controller 62 of the logic layer 52. In the embodiment shown in FIG. 2, one of the readers 64 is in direct communication with the logic controller 62, while another reader 66 is communicating with the logic controller 62 indirectly, that is by first passing its data to the direct contact reader 64.

The system 50 also includes the tag layer 56. The tag layer 56 comprises large sets of tags (depicted as T in FIG. 2). In one embodiment, the system 50 provides for reading and management of thousands of tags.

As each tag or sets of tags moves to proximity of a reader R, a tag 68 T will become activated and be read by a reader R.

Readers R of the reader layer 54 transmit to the logic controller 62 information including the identifier of the tag T being read by the reader R as well as the signal strength of the reading of the tag T.

For purposes of clarity of FIG. 2, the tags are shown as physical separated from the readers R. In use, the tags T should be in frequent communication with readers R with few areas of the facility not covered by a detection field of a reader R. Further, while the tag 62 being interrogated 68 by the reader R is shown as being interrogated by a single reader, in practice multiple readers may be interrogating the same tag in close proximity to one another.

The communication between the reader layer 54 and the logic layer 52 is accomplished using wireless media, in one example. Each reader R comprises an antenna to activate the tag T as well as an antenna to communicate with the logic controller 62. In one embodiment both antennas use Bluetooth. In another embodiment, Bluetooth or Bluetooth Low Energy (le) is used to activate the tag T while a WIFI connection is established in order to communicate with the logic controller 62.

### Tags

In one embodiment, the tags comprising the tag layer 56 are attached to all items to be tracked within the system. The assets to be tracked include trays, compartments, totes, ID cards of staff members, vehicles, actuator arms, and other components. In one embodiment, the tags T are attached using a removable adhesive. For some assets, the tags T include autonomously broadcasting elements. While in most applications each tracked item has its own tag T, in other applications certain containers have multiple tags T. For example, in one embodiment totes designed to store multiple items have multiple tags.

The tag layer 56 allows for tracking of any asset, not merely high-value items. The tag layer 56 can be used to track the entire inventory of a warehouse, components used in a process, and others. In one embodiment, the tag layer 56 is used to track the use level of an expendable item, such as amount of medicine in a container. In this embodiment, the tag layer is used to indicate whether the item is empty, expired, damaged, or other status, based on the tracked item's pattern of use, its proximity to other equipment and other parameters.

In one embodiment, a passive tag T includes am Ultra High Frequency (UHF) antenna which is activated by a radio-frequency field generated by a reader, and a response signal is broadcast upon activation. In one embodiment, some tags are self-powered and send a response signal upon receiving the appropriate signal from a reader.

In one embodiment, the tags cost between $0.10 to 0.50 per unit and each tag has a broadcast range of 3 to 30 feet. Each tag has a useable life of 5 to 10 years.

### Readers

The reader layer 54 comprises a set of readers R, as shown in FIG. 2. In one embodiment, the location of the readers R is determined on basis of real-world performance characteristics of the physical location where the system is being implemented. For example, in some embodiments, as part of the layout of readers R, measurements of interference are completed.

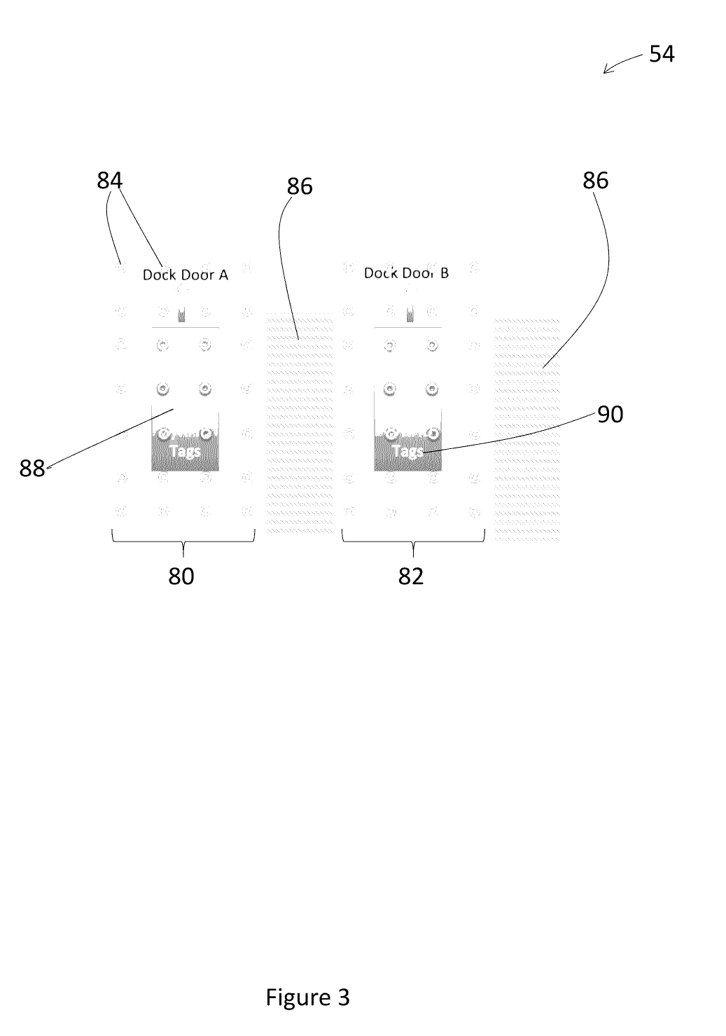

Turning to FIG. 3, depicted therein is one arrangement of the reader layer 54. The reader layer 54 comprises an array 80, 82 of individual readers 84.

As shown in FIG. 3, the first array 80 of readers comprises an array of 4 by 7 readers for a total of 28 readers. The second array 82 likewise contains 28 readers. As each forklift 88, 90 traverses the array 80, 82, the tags held on the forklift 88, 90 are read by several readers 84. The readers then forward the data to the logic controller 62 (not shown in FIG. 3).

The reader layer 54 is customizable in that areas of the facility which are inaccessible to product, such as closed off areas 86 do not require reader tags to be placed therein. The density of the first array 80 and the second array 82 is set to correspond to the maximum velocity of the first 88 and second 90 forklift. In one embodiment, the operator of the respective forklift 88, 90 is notified if the speed of traversal of the array 80, 82 exceeds the maximum speed rating.

In the embodiment shown in FIG. 3, the readers are placed in an array such that at any given time the products on each forklift are in communication with at least six readers 84. In one embodiment, the grid defined by either array 80, 82 has individual reader 84 within 30 feet of one another, as required to activate the UHF tags discussed infra.

The density of the array 80, 82 is determined in response to interference, type of product to be tracked, and activity being performed in a given area. For example, grid patterns are used for the following products:

Product Containers Comprising Primarily Dry Goods
Metallic or Magnetized Components
High Value Medical Products
Slow Moving Bulky Containers

As can be appreciated, the amount of expected interference is an important factor in designing the array 80, 82. However, the grid cannot be too dense by having too many individual readers 84. This would increase the cost of covering a warehouse or other facility, and would result in interference.

In one embodiment, the individual reader 84 comprises a low cost active element comprising a UHF activation system and a simple communication system for transmitting data to the logic controller 62.

In one embodiment, the readers 84 comprise a Bluetooth LE sensor with a 330 foot range and a cost of $20 to $100 per unit. The reader 84 includes a non-rechargeable battery, but it is user replaceable.

In one embodiment, each reader 84 includes a standards-compliant network and management interface such as the Zigbee communication protocol. In one embodiment, the readers 84 forward information from each other to the logic controller 62 using a mesh routing protocol. In one embodiment, the information transmitted by each reader 84 is encrypted.

### Logic Layer Embodiments

The logic layer 52 receives data from the individual readers 84. The logic layer 52 includes at least one logic controller 62. In one embodiment, the logic layer also comprises a number of intermediary devices which collect data from the individual readers 84. The logic layer 52 is responsible for turning the data received from the individual readers 84 into actionable reports.

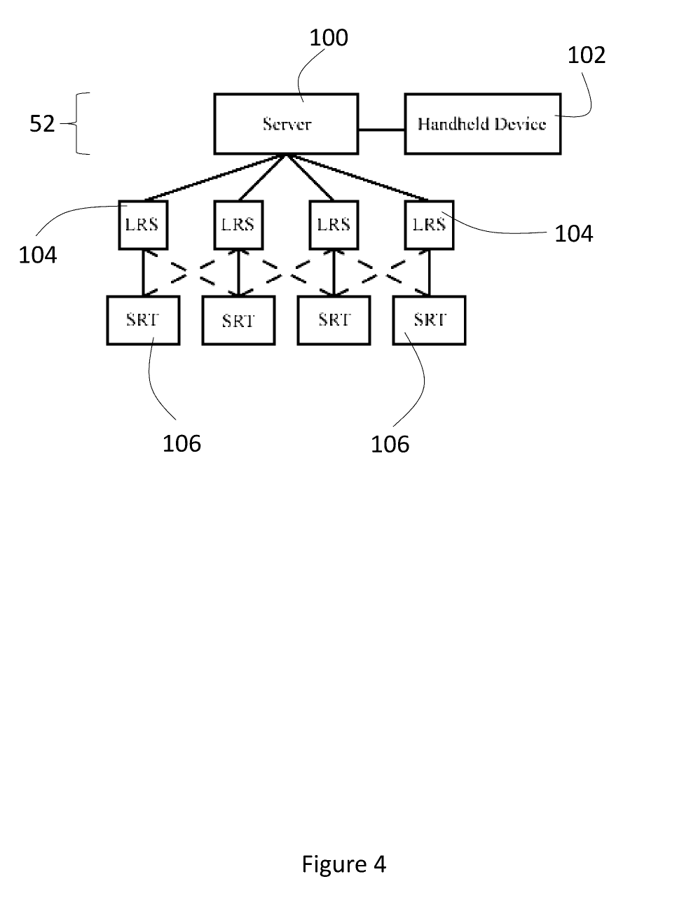

In one embodiment, shown in FIG. 4, the logic layer 52 comprises a server 100 and at least one handheld device 102. The handheld device interfaces with the server and assists in the communication with the tag readers 104. The tag readers 104 are in intermittent communication with the tags 106. The handheld device 102 does not read the individual tags 106.

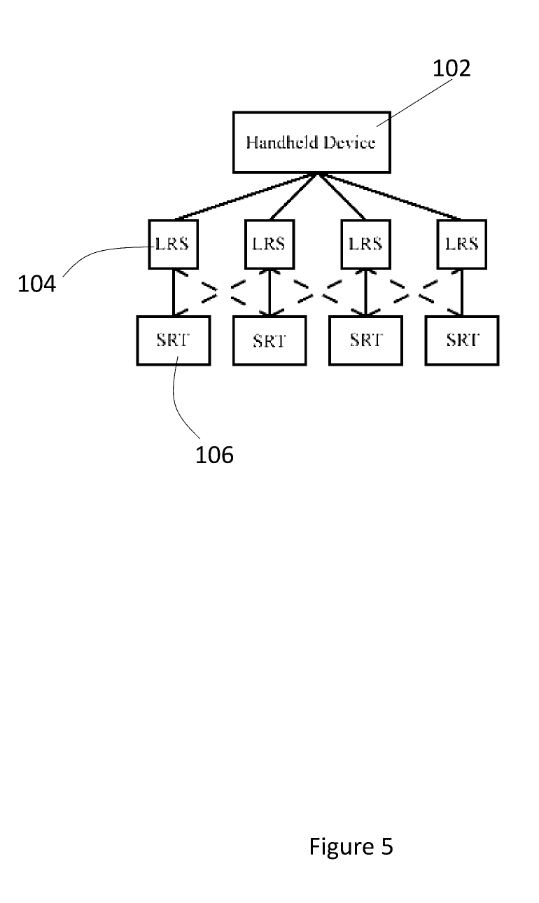

A handheld device 102 may also communicate directly with the readers 104, as shown in FIG. 5.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

The triangulation of signals is performed by the logic layer 52 by compiling signal strength readings from individual tags as they pass in proximity to particular readers 84.

In one embodiment, the location of all readers 84 is mapped as an initial step in the design of the system.

### Data Transmission Details

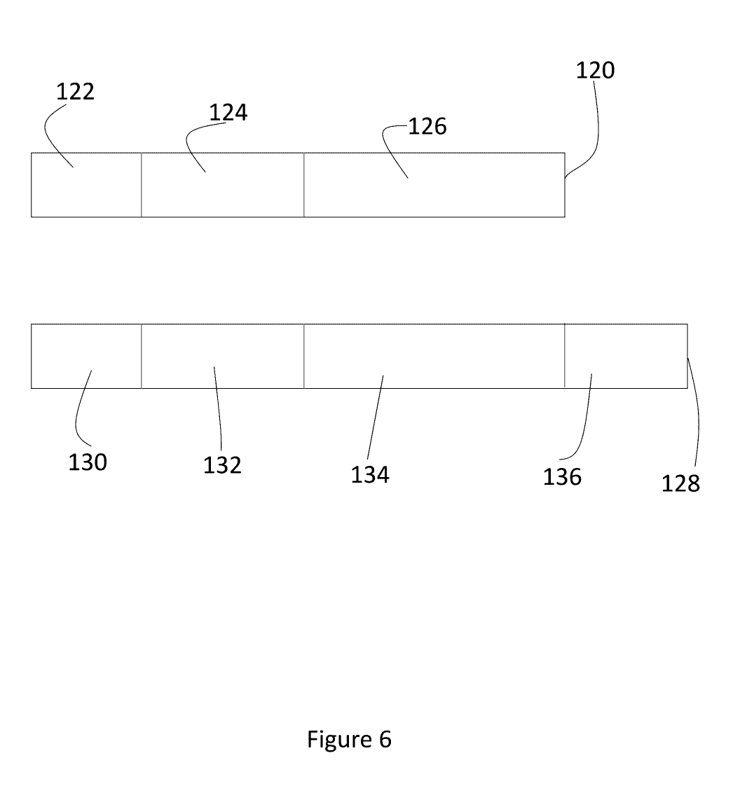

The details of the data being transmitted by each of the tags is shown in FIG. 6. A sample data packet of the data sent from a tag to a reader comprises a header 122 and a payload. The payload includes a tag identifier 124 and a signal strength value 126.

Upon being received by a reader, the data packet 120 is forwarded to the logic controller by the receiving reader. The data packet from the reader 128 comprises a similar header 130 and payload. The payload in turn comprises the tag identifier 132, signal strength value 134 and reader identifier 136.

While in FIG. 6 the information is shown as being sent as a single packet, in various embodiments the information is sent using payloads having many packets. In one embodiment, the header 122 of the tag packet 120 is different from the header of the reader packet 128 inasmuch as the tag packet 120 is not addressed to a specific reader.

In one embodiment, the signal strength value 126, 134 includes a time stamp for the signal strength measurement. In another embodiment, the time value is stored in the header 122, 130.

### Triangulation Details

In one embodiment, multiple readings of the signal strength values 134 received from the reader data packet 128 are used to triangulate the location of a tag. In one embodiment, as the number of readers increases, the triangulation becomes more precise.

In one embodiment, in order to triangulate a tag the logic controller 62 compares the signal strength value of the tag with neighboring tags, especially where one of the neighboring tags has already been triangulated.

In one embodiment, the triangulation results include both a location at a given time as well as a direction of movement.

### Communication Details

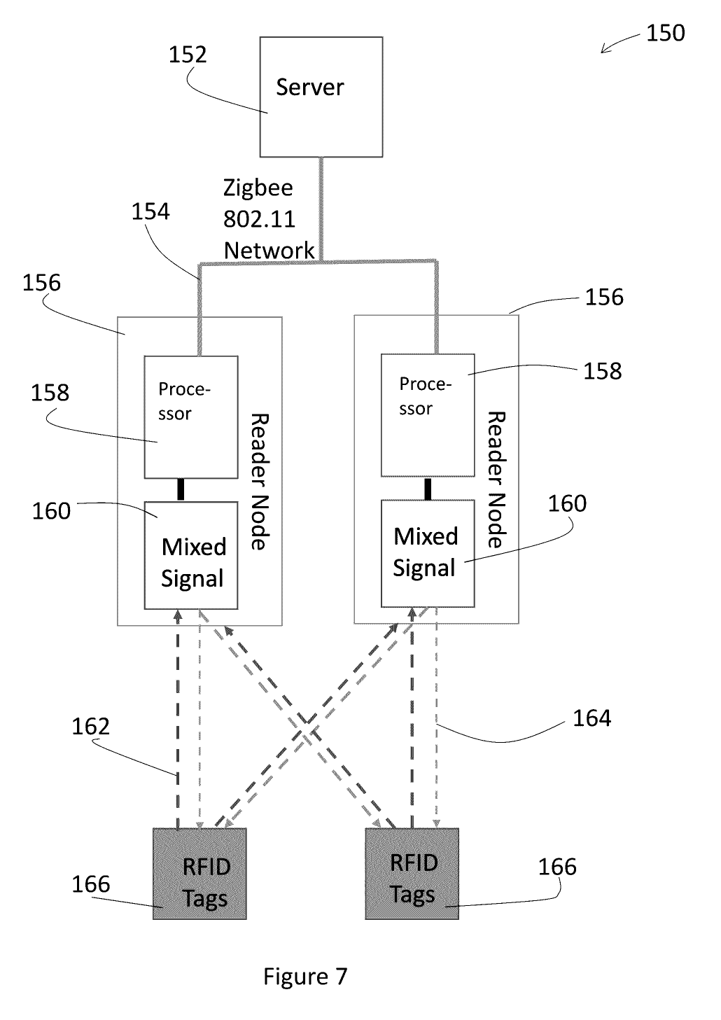

The details of communication between the various layers are depicted in FIG. 7. The depicted embodiment 150 of the system comprises a server 152 in communication with the reader nodes 156 using a wireless network 154. The wireless network, as shown in FIG. 7 comprises a Zigbee 802.11-compliant network. The wireless network 154 is received by each node 156. As shown in FIG. 7, the wireless network 154 operates on shared media, such as wireless spectrum, but each node 156 has a connection to the server 152. The reader node 156 connection 154 to the server 152 is constant and directed, unlike the tag signal network 162 which is intermittent and the signals sent by the tags are not addressed to any particular reader 156.

Each reader node 156 comprises a processor unit 158, which in turn comprises a data exchange bus, central processing unit, and memory (individual components not shown). The bus connects the processor unit 158 to the mixed signal interface 160. The server 152 connection 154 is also coupled to the central processor. In instances where the connection 154 is not available, readings from the mixed signal receiver 160 are stored in cache memory within the processor unit 158. However, as the system is designed for real-time analysis, the data in cache memory is not stored indefinitely and has an expiration date and time for when a node 158 is isolated from a server 152 connection (either a direct connection or a connection through a neighbor node).

The mixed signal receiver 160 provides an energizing radio frequency signal 164. Upon being energized, the node 166 broadcasts an identifier signal 162. In the depicted embodiment, the identifier signal 162 and the energizing signal 164 are broadcast over a wide area and are received by as many different tags 166 and receivers 160 as possible.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The embodiment of the invention in which an exclusive property or privilege is claimed is defined as follows:

1. A system for location of assets on a premises comprising:
an RFID tag attached to an asset to be tracked;
an array of RFID tag readers placed in known locations within said premises wherein said RFID tag readers activate and obtain tag information from each tag; and
a control logic wherein said control logic reads information from said array of RFID tags;
wherein said control logic triangulates the position of each tracked asset.

2. The system of claim 1 further comprising a handheld reader which obtains information from said RFID tag readers.

3. The system of claim 1 wherein said tag information received from each tag comprises a tag identifier and a signal strength value.

4. The system of claim 3 wherein said signal strength value of said tag is used by the control logic to triangulate the position of each tracked asset.

5. The system of claim 1 wherein RFID tags are inexpensive passive tags.

6. The system of claim 1 wherein said RFID tag readers comprise a battery-powered tag interrogator.

7. The system of claim 1 wherein said RFID tag readers are in communication with one another.

8. The system of claim 1 wherein said array of RFID tag readers comprises regularly-spaced grid of RFID readers.

9. The system of claim 8 wherein said grid of RFID tag readers is installed in a floor of the premises in areas where tracked assets move.

10. The system of claim 1 wherein said RFID readers comprise active RFID tags.
